(19) United States
(12) Patent Application Publication
(10) Pub. No.: US 2025/0030539 A1
(43) Pub. Date: Jan. 23, 2025

(54) BLOCKCHAIN-BASED MULTI-NODE AUTHENTICATION METHOD AND SYSTEM

(71) Applicant: FNSVALUE CO., LTD., Seoul (KR)

(72) Inventor: Seung Ju JEON, Seoul (KR)

(73) Assignee: FNSVALUE CO., LTD., Seoul (KR)

(21) Appl. No.: 18/364,593

(22) Filed: Aug. 3, 2023

(30) Foreign Application Priority Data
Jul. 18, 2023 (KR) 10-2023-0092796

(51) Int. Cl. H04L 9/08; H04L 9/00

(52) U.S. Cl. CPC H04L 9/0819; H04L 9/50

(57) ABSTRACT

A blockchain-based multi-node authentication method capable of improving the security and convenience of user (or user terminal) authentication is provided. The method includes at least: receiving an authentication preparation request from a first user; generating a temporary channel and a channel key for identifying the temporary channel in response to the authentication preparation request, the temporary channel including multiple nodes respectively corresponding to multiple second user terminals, which are to be involved in the authentication of the first user terminal; collectively transmitting the channel key to the nodes and distributedly transmitting authentication comparison data; receiving an authentication request, which includes the channel key and authentication target data regarding the first user terminal, from the first user terminal; and proceeding with the authentication of the first user terminal in response to receiving the authentication request, the authentication of the first user terminal including first and second authentication processes.

### CROSS-REFERENCE TO RELATED APPLICATION

This application claims priority from Korean Patent Application No. 10-2023-0092796 filed on Jul. 18, 2023, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a blockchain-based multi-node authentication method and system, and more particularly, to a method and system for strengthening the security and convenience of authentication of a user or a user terminal through blockchain-based multi-node authentication.

### 2. Description of the Related Art

With the advancement of information and communication technology, as information becomes more concentrated online, the importance of information protection and security is increasing. To complement traditional password-based authentication, public key-based authentication or passwordless authentication methods have been developed. However, these methods still have vulnerabilities and are exposed to numerous security threats.

Especially, existing authentication methods utilize authentication information based on unique user-owned information to generate security keys. In the process of generating security keys, traditional (or conventional) security key generation algorithms are used, which poses a risk of exposing security keys if the authentication information is compromised.

### SUMMARY

Aspects of the present disclosure provide a method and system for strengthening the security and convenience of user (or user terminal) authentication through blockchain-based multi-node authentication.

Aspects of the present disclosure also provide a method of generating a one-time or temporary security key by automatically collecting authentication elements of multiple user terminals based on a distributed ledger technology and randomly extracting and combining the collected authentication elements, and a system to which the method is applied.

Aspects of the present disclosure also provide a method of strengthening the security and convenience of user (or user terminal) authentication by randomly selecting multiple user terminals involved in authentication, and a system to which the method is applied.

Aspects of the present disclosure also provide a method of strengthening the security and convenience of user (or user terminal) authentication by randomly selecting an authentication server in which authentication is to be performed, and a system to which the method is applied.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, a blockchain-based multi-node authentication method performed by a computing system includes: receiving an authentication preparation request from a first user; generating a temporary channel, in which the authentication of a first user terminal of the first user is to be performed, and a channel key for identifying the temporary channel in response to the authentication preparation request, the temporary channel including multiple nodes respectively corresponding to multiple second user terminals, which are to be involved in the authentication of the first user terminal and are randomly selected from user terminals other than the first user terminal; collectively transmitting the channel key to the nodes and distributedly transmitting authentication comparison data, which is to be used in the authentication of the first user terminal, among the nodes; transmitting an authentication preparation completion message, which includes the channel key, to the first user terminal; receiving an authentication request, which includes the channel key and authentication target data regarding the first user terminal, from the first user terminal; proceeding with the authentication of the first user terminal in response to receiving the authentication request, the authentication of the first user terminal including first and second authentication processes, the first authentication process being an authentication process using a security key transmitted to the first user terminal and some of the nodes that is randomly selected, the security key being generated by randomly extracting and combining authentication elements collected from the first user terminal and the second user terminals, and a second authentication process being an authentication process using the distributedly-transmitted authentication target data and the distributedly-transmitted authentication comparison data; receiving a result of comparison between the distributedly-transmitted authentication comparison data and the distributedly-transmitted authentication target data from the nodes; and determining the success of the authentication of the first user terminal based on the received result of comparison between the authentication comparison data and the authentication target data, wherein the authentication comparison data and the authentication elements collected from the second user terminals may be obtained from a distributed ledger.

The proceeding with the authentication of the first user terminal may include transmitting a security key to the first user terminal and the randomly-selected node in response to receiving the authentication request, receiving a first hash value, which is obtained by the first user terminal's conversion of the security key, and a second hash value, which is obtained by the randomly-selected node's conversion of the security key, and determining the first authentication process to be successful if the first and second hash values match.

The security key may be a one-time or temporary security key.

Both the authentication comparison data and the authentication target data may be classified into multiple categories, the distributedly transmitting the authentication comparison data among the nodes may include partitioning the authentication comparison data based on the categories and transmitting the partitioned authentication comparison data to different nodes, and the proceeding with the authentication of the first user terminal may include partitioning the authentication target data based on the categories and transmitting the partitioned authentication target data to the different nodes according to the same categories as the partitioned authentication comparison data.

The determining the success of the authentication of the first user terminal may include determining the second authentication process to be successful if a result is received from more than a predetermined number of nodes showing that the distributedly-transmitted authentication comparison data and the distributedly-transmitted authentication target data match.

The blockchain-based multi-node authentication method may further include: if the determining the first authentication process to be successful is completed, deleting the temporary channel, the channel key, and the security key.

The receiving the authentication preparation request from the first user may include randomly selecting a particular authentication server, in which the first and second authentication processes are to be performed, from among a plurality of authentication servers.

According to another aspect of the present disclosure, a blockchain-based multi-node authentication system includes: a communication interface; a memory in which a computer program is loaded; and a processor executing the computer program, wherein the computer program includes: instructions for receiving an authentication preparation request from a first user; instructions for generating a temporary channel, in which the authentication of a first user terminal of the first user is to be performed, and a channel key for identifying the temporary channel in response to the authentication preparation request, the temporary channel including multiple nodes respectively corresponding to multiple second user terminals, which are to be involved in the authentication of the first user terminal and are randomly selected from user terminals other than the first user terminal; instructions for collectively transmitting the channel key to the nodes and distributedly transmitting authentication comparison data, which is to be used in the authentication of the first user terminal, among the nodes; instructions for transmitting an authentication preparation completion message, which includes the channel key, to the first user terminal; instructions for receiving an authentication request, which includes the channel key and authentication target data regarding the first user terminal, from the first user terminal; instructions for proceeding with the authentication of the first user terminal in response to receiving the authentication request, the authentication of the first user terminal including first and second authentication processes, the first authentication process being an authentication process using a security key transmitted to the first user terminal and some of the nodes that is randomly selected, the security key being generated by randomly extracting and combining authentication elements collected from the first user terminal and the second user terminals, and a second authentication process being an authentication process using the distributedly-transmitted authentication target data and the distributedly-transmitted authentication comparison data; instructions for receiving a result of comparison between the distributedly-transmitted authentication comparison data and the distributedly-transmitted authentication target data from the nodes; and instructions for determining the success of the authentication of the first user terminal based on the received result of comparison between the authentication comparison data and the authentication target data, and the authentication comparison data and the authentication elements collected from the second user terminals are obtained from a distributed ledger.

The instructions for proceeding with the authentication of the first user terminal may include instructions for transmitting a security key to the first user terminal and the randomly-selected node in response to receiving the authentication request, instructions for receiving a first hash value, which is obtained by the first user terminal's conversion of the security key, and a second hash value, which is obtained by the randomly-selected node's conversion of the security key, and instructions for determining the first authentication process to be successful if the first and second hash values match.

Both the authentication comparison data and the authentication target data may be classified into multiple categories, the instructions for distributedly transmitting the authentication comparison data among the nodes may include instructions for partitioning the authentication comparison data based on the categories and transmitting the partitioned authentication comparison data to different nodes, and the instructions for proceeding with the authentication of the first user terminal may include instructions for partitioning the authentication target data based on the categories and transmitting the partitioned authentication target data to the different nodes according to the same categories as the partitioned authentication comparison data.

The instructions for receiving the authentication preparation request from the first user may include instructions for randomly selecting a particular authentication server, in which the first and second authentication processes are to be performed, from among a plurality of authentication servers.

### BRIEF DESCRIPTION OF THE DRAWINGS

The above and other aspects and features of the present disclosure will become more apparent by describing in detail exemplary embodiments thereof with reference to the attached drawings, in which:

FIGS. 1 and 2 are schematic diagrams of a system according to an embodiment of the present disclosure;

FIG. 3 is a flowchart illustrating a blockchain-based multi-node authentication method according to an embodiment of the present disclosure;

FIG. 4 is a flowchart illustrating some steps of the blockchain-based multi-node authentication method according to an embodiment of the present disclosure;

FIG. 5 is a schematic diagram illustrating how to generate a security key by randomly extracting and combining authentication elements collected from user terminals;

FIGS. 6 and 7 are tables showing the authentication element configurations of various security keys that can be generated in accordance with some embodiments of the present disclosure; and

FIG. 8 is a hardware configuration view of a computing system according to some embodiments described in this disclosure.

### DETAILED DESCRIPTION

Preferable embodiments of the present disclosure will hereinafter be described with reference to the accompanying drawings. The advantages and features of the present invention, as well as methods to achieve them, will become clear when referring to the detailed descriptions and embodiments provided with the attached drawings. However, the technical ideas of the present invention are not limited to the described embodiments but can be implemented in various other forms. The disclosed embodiments are provided to fully disclose the scope of the present invention to those skilled in the art with ordinary knowledge in the relevant field, and the technical ideas of the present invention are solely defined by the scope of the claims.

In explaining various embodiments of the present disclosure, specific descriptions related to known components or functions may be omitted if it is deemed that such descriptions may obscure the essence of the present invention.

Unless otherwise defined, the terminology (including technical and scientific terms) used in the following embodiments can be understood by those skilled in the art with ordinary knowledge in the relevant field, although interpretations may vary depending on the intent of the skilled person or court precedents, or the emergence of new technologies. The terminology used in this disclosure is for the purpose of describing embodiments and does not limit the scope of the present invention.

The singular expressions used in the following embodiments include plural concepts, unless specifically determined as singular in the context. Similarly, plural expressions include singular concepts unless specifically determined as plural in the context.

Furthermore, terms such as “first,” “second,” “A,” “B,” “(a),” “(b),” etc., used in the following embodiments are merely used to distinguish one component from another, and do not limit the essence, order, or sequence of the respective components.

Various embodiments of the present disclosure will hereinafter be described with reference to the accompanying drawings.

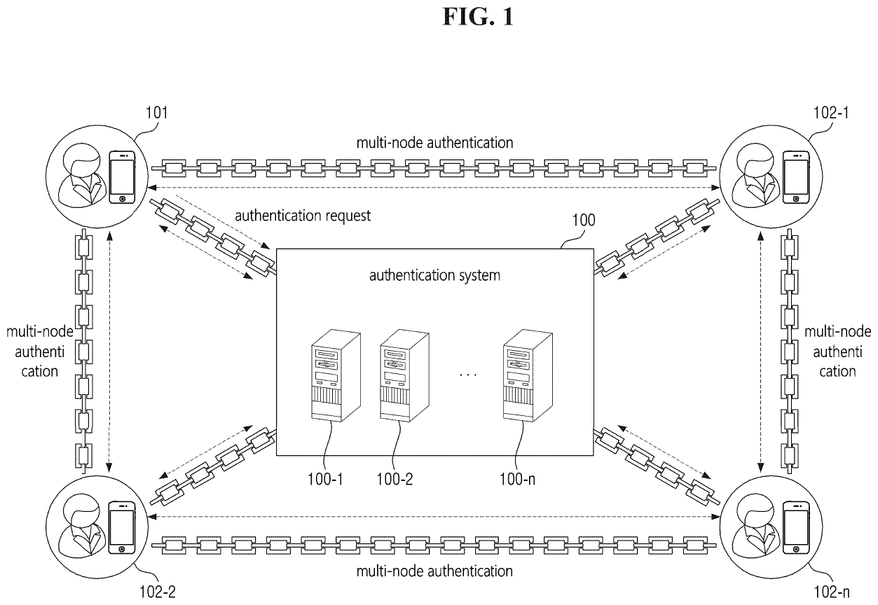

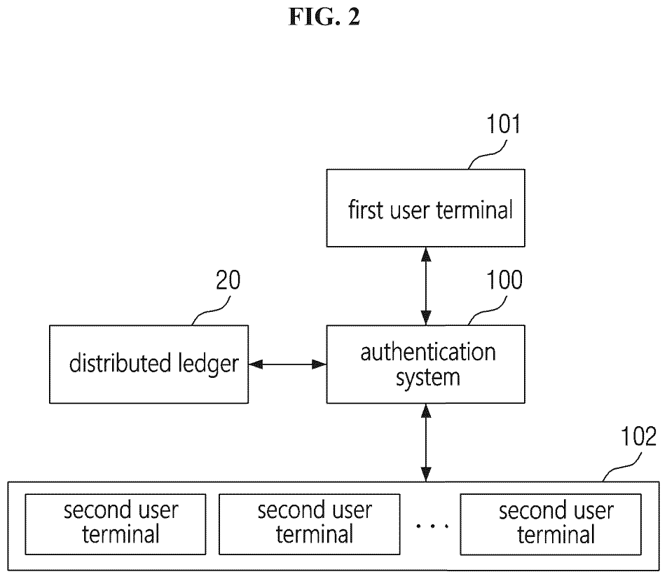

FIGS. 1 and 2 are schematic diagrams of a system according to an embodiment of the present disclosure.

The configuration and operation of the system according to an embodiment of the present disclosure will hereinafter be described with reference to FIGS. 1 and 2.

Referring to FIGS. 1 and 2, the system according to an embodiment of the present disclosure may include an authentication system 100. In some embodiments, the system according to an embodiment of the present disclosure may include a first user terminal 101, which is an authentication target, and a plurality of nodes 102-1 through 102-n. For example, the system according to an embodiment of the present disclosure may include a plurality of nodes 102-1 through 102-n, which correspond to a plurality of second user terminals 102 that are to be involved in the authentication of the first user terminal 101. It should be understood that the first user terminal 101 may also refer to and/or include the node corresponding to the first user terminal 101 depending on the context and/or implementation.

In some embodiments, the authentication system 100 may be connected to various service provider systems (not illustrated), such as portals, platforms, banking systems, etc. In this case, the service provider systems may employ a blockchain-based multi-node authentication method according to an embodiment of the present disclosure to conduct user authentication, such as login, for receiving the respective services. At least some functionalities of the authentication system 100 may be included in the service provider systems in the form of program modules.

The first user terminal 101 and the second user terminals 102 will hereinafter be described as being, for example, smartphones. However, the type of user terminals is not particularly limited, and various types of computing systems within the scope of the present disclosure, such as desktops and laptops, can be implemented to achieve the objectives of the present disclosure. Additionally, the first user terminal 101 and the second user terminals 102 may communicate with the authentication system 100 through a communication network (not illustrated). The communication network may include various types of wired or wireless networks, such as Local Area Networks (LANs), Wide Area Networks (WANs), mobile radio communication networks, and Wireless Broadband Internet (WiBro).

In some embodiments, the authentication system 100 may include one or more authentication servers 100-1 to 100-n, and each of the authentication servers 100-1 to 100-n may function as a node on a blockchain network (e.g., a private blockchain network). Moreover, in some embodiments, each of the authentication servers 100-1 to 100-n may store or have access to a distributed ledger 20. Each of the authentication servers 100-1 to 100-n may include an authentication module (not illustrated), which performs the blockchain-based multi-node authentication method according to one embodiment of the present disclosure, in the form of a library.

A plurality of blocks that constitute the distributed ledger 20 may include information on the first user terminal 101 and the second user terminals 102. For example, a particular block of the distributed ledger 20 may include information on a particular user terminal. As information on each user terminal may be stored in a block on a blockchain network, the corresponding information may not be tampered with.

In some embodiments, information on a user terminal may refer to authentication data registered by a user when subscribing to the authentication system 100 or other services that utilize the authentication system 100 using his or her user terminal. Information on a user terminal may also be referred to as an authentication element in connection with a first authentication process and as authentication comparison data or authentication target data in connection with a second authentication process.

Information on a user terminal may include at least one of, for example, region detection information, knowledge-based information, device information, and ownership information. In some embodiments, information on a user terminal may also include biometric recognition information. The region detection information may include radio frequency identifier (RFID) tags, WiFi Service Set Identifiers (SSIDs), beacons, and values from sensors (e.g., proximity sensors, light sensors, vibration sensors, etc.). The knowledge-based information, which refers to information set and stored based on the user's knowledge, may include the user's email addresses, identifiers (IDs), passwords, patterns, etc., and the IDs may be Android IDs. The device information may include a unique serial number of the user terminal, sensor identifiers, Universal Unique Identifiers (UUID), status information, Media Access Control (MAC) addresses, Bluetooth addresses, etc. The status information, which refers to various information for verifying the status of the user terminal, may include volume level, vibration/ring state, etc. The ownership information may include a designated phone number, near-field communication (NFC) tag, a quick response (QR) code, a barcode, etc., specified by the user when using the user terminal. The biometric recognition information may include fingerprints, iris, and other biometric information registered by the user for biometric recognition.

The authentication system 100 may enable authentication of a user terminal or a user through blockchain-based multi-node authentication. For example, the authentication system 100 may receive an authentication preparation request from a first user and may create a temporary channel, in which authentication of the first user's terminal, i.e., the first user terminal 101, is to be performed, and a channel key, which is for identifying the temporary channel, in response to the authentication preparation request. The temporary channel may include the nodes 102-1 through 102-n, which correspond to the second user terminals 102 that are involved in the authentication of the first user terminal 101. The second user terminals 102 may be randomly selected from among user terminals other than the first user terminal 101.

Thereafter, the authentication system 100 may collectively transmit the channel key to the nodes 102-1 through 102-n and may distributedly transmit authentication comparison data, which is to be used in the authentication of the first user terminal 101, among the nodes 102-1 through 102-n. Furthermore, the authentication system 100 may transmit an authentication preparation completion message containing the channel key to the first user terminal 101. The authentication comparison data may be acquired from the distributed ledger 20.

Thereafter, the authentication system 100 may receive an authentication request, which includes the channel key and authentication target data for the first user terminal 101, from the first user terminal 101. In response to receiving the authentication request, the authentication system 100 may proceed with the authentication of the first user terminal 101. The authentication of the first user terminal 101 may include both the first and second authentication processes. Here, the first authentication process is an authentication process using a security key transmitted to the first user terminal 101 and some of the nodes 102-1 through 102-n that is randomly selected, and the security key may be generated by randomly extracting and combining authentication elements collected from the first user terminal 101 and the second user terminals 102. The authentication elements collected from the second user terminals 102 may be obtained from the distributed ledger 20. The second authentication process may be an authentication process using the authentication target data and the authentication comparison data, distributedly transmitted among the nodes 102-1 through 102-n.

Thereafter, the authentication system 100 may receive the result of comparison between the distributedly-transmitted authentication comparison data and the distributedly-transmitted authentication target data from the nodes 102-1 through 102-n and may determine whether the authentication of the first user terminal 101 has succeeded based on the received result of comparison between the authentication comparison data and the authentication target data.

The configuration and operation of the system according to an embodiment of the present disclosure have been described. In particular, the operation of the authentication system 100 can be better understood through the following embodiments, which serve as supplements to the understanding of the operation of the authentication system 100.

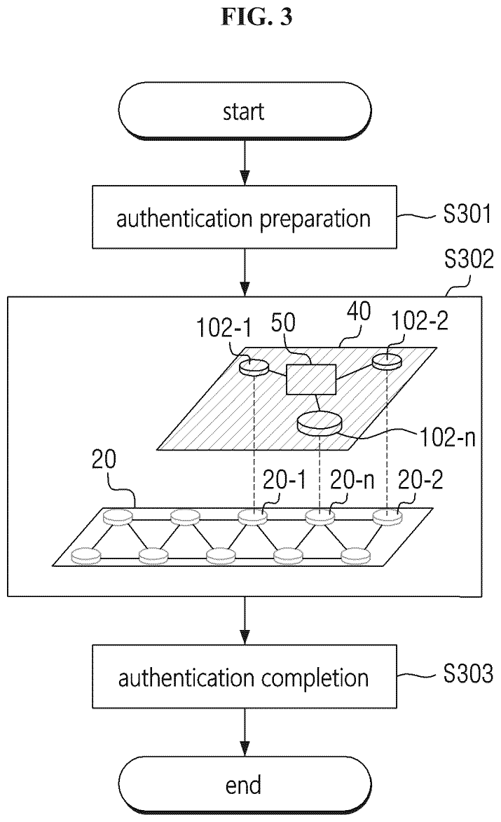

A blockchain-based multi-node authentication method according to an embodiment of this disclosure will hereinafter be described with reference to FIGS. 3 through 7. The blockchain-based multi-node authentication method according to an embodiment of the present disclosure may be performed by one or more computing systems. Alternatively, some operations of the blockchain-based multi-node authentication method according to an embodiment of the present disclosure may be performed by a first computing system, while the remaining operations may be performed by a second computing system.

For example, some operations of the blockchain-based multi-node authentication method according to an embodiment of the present disclosure may be performed by an on-premise physical server, and the remaining operations may be performed by a cloud server. The operations of the blockchain-based multi-node authentication method according to an embodiment of the present disclosure may generally be understood as being performed by computing systems unless specified otherwise.

FIG. 3 is a flowchart illustrating a blockchain-based multi-node authentication method according to an embodiment of the present disclosure.

Referring to FIG. 3, in an authentication preparation procedure (S301), the first user may send an authentication preparation request to the authentication system 100. The first user may directly send the authentication preparation request to the authentication system 100 directly via an application client installed on the first user terminal 101. Alternatively, the first user may send the authentication preparation request indirectly to the authentication system 100 via a web client on a different terminal, such as a personal computer (PC). In the latter case, after the authentication preparation procedure (S301) is completed, the first user terminal 101 is required to send an authentication request directly to the authentication system 101, enabling the authentication system 100 to receive the authentication target data for the first user terminal 101 from the first user terminal 101.

Upon receiving the authentication preparation request, the authentication system 100 may randomly select multiple second user terminals 102, which are to be involved in the authentication of the first user terminal 101, from among a plurality of terminals currently being connected. The authentication system 100 may then create a temporary channel 40, which includes the nodes 102-1 through 102-n that correspond to the randomly-selected second user terminals 102. Thereafter, the authentication system 100 may collectively transmit a channel key for identifying the temporary channel 40 to the nodes 102-1 through 102-n and may distributedly transmit the authentication comparison data, which is for the authentication of the first user terminal 101, among the nodes 102-1 through 102-n.

In some embodiments, in S301, a security key may be transmitted to the first user terminal 101 and the randomly-selected some node(s) among the nodes 102-1 through 102-n, but the present disclosure is not limited thereto. Alternatively, the security key may be transmitted upon receiving an authentication request from the first user terminal 101 after the authentication preparation procedure is completed.

Once the authentication preparation process (S301) is completed, an authentication procedure (S302) is performed. Specifically, the authentication system 100 may receive an authentication request from the first user terminal 101. The authentication request includes the channel key of the temporary channel 40 and the authentication target data, which is target data to be authenticated. The authentication target data may be distributedly transmitted among the nodes 102-1 through 102-n of the temporary channel 40 in the same manner (or based on the same categories) as the authentication comparison data (S302). Alternatively, in some embodiments, after the successful completion of the first authentication process, as will be described later, the authentication system 100 may distributedly transmit the authentication target data among the nodes 102-1 through 102-n.

In the authentication process (S302), some of the nodes 102-1 through 102-n, for example, one of the nodes 102-1 through 102-n, may be randomly selected to perform the first authentication process on the first user terminal 101 using the security key.

Moreover, in the authentication process (S302), the nodes 102-1 through 102-n of the temporary channel 40 may perform the second authentication process on the first user terminal 101 by comparing the authentication comparison data and the authentication target data, distributedly transmitted thereamong from the authentication system 100, and may then transmit the result of the comparison to the authentication system 100. In this case, a predetermined consensus algorithm 50 may be utilized to determine the success of the second authentication process.

Meanwhile, the nodes 102-1 through 102-n of the temporary channel 40 may obtain the authentication comparison data from a plurality of blocks 20-1 through 20-n constituting the distributed ledger 20. Each of the blocks 20-1 through 20-n may store information on the second user terminals 102.

The authentication system 100 may complete the authentication of the first user terminal 101 based on comparison result data received from the nodes 102-1 through 102-n (S303). If the authentication of the first user terminal 101 is successful, the authentication system 100 may allow access by the first user terminal 101. However, if the authentication of the first user terminal 101 fails, the authentication system 100 may deny access by the first user terminal 101.

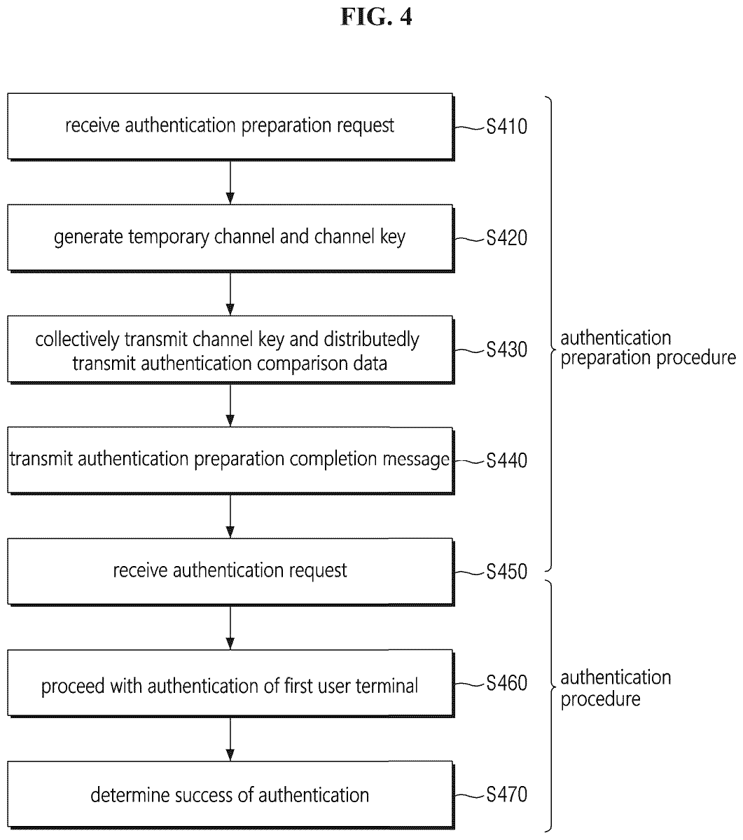

The authentication preparation procedure (S301) and the authentication procedure (S302) will hereinafter be described with reference to FIG. 4.

FIG. 4 is a flowchart illustrating some steps of the blockchain-based multi-node authentication method according to an embodiment of the present disclosure.

Referring to FIG. 4, the authentication system 100 may receive an authentication preparation request from the first user (S410). The authentication system 100 may randomly select a particular authentication server from among a plurality of authentication servers 100-1 through 100-n to perform the authentication of the first user terminal 101. The randomly-selected particular authentication server may create a temporary channel 40 to proceed with the authentication of the first user terminal 101. Since the temporary channel 40 exists only for a short period of time, for example, about 2 seconds, it becomes highly difficult for attackers to identify the particular authentication server during this short period of time and even interfere with the authentication of the first user terminal 101 within the temporary channel 40. Consequently, the overall security can be further enhanced.

Although the blockchain-based multi-node authentication method according to an embodiment of the present disclosure will hereinafter be described as being performed mostly by the authentication system 100, it should be understood that when a particular authentication server is randomly selected from among the authentication servers 100-1 through 100-n to authenticate the first user terminal 101, the blockchain-based multi-node authentication method according to an embodiment of the present disclosure can be performed by the randomly-selected particular authentication server.

Thereafter, multiple second user terminals 102, which are to be involved in the authentication of the first user terminal 101, may be randomly selected by the authentication system 100 from among all the user terminals other than the first user terminal 101. Then, the authentication system 100 may create a temporary channel 40, which includes the nodes 102-1 through 102-n that correspond to the randomly-selected second user terminals 102, and a channel key for identifying the temporary channel 40 (S420).

Thereafter, the authentication system 100 may collectively transmit the channel key to all the nodes 102-1 through 102-n of the temporary channel 40 and may distributedly transmit authentication comparison data among the nodes 102-1 through 102-n of the temporary channel 40 (S430). That is, the authentication system 100 may transmit the same channel key to all the nodes 102-1 through 102-n of the temporary channel 40, but may divide the authentication comparison data into a number of sections corresponding to the number of nodes in the temporary channel 40 and transmit the sections to different nodes of the temporary channel 40. Accordingly, each of the nodes 102-1 through 102-n of the temporary channel 40 may receive only a part of the authentication comparison data, and the received parts of the authentication comparison data may differ among the nodes 102-1 through 102-n of the temporary channel 40.

The distributed transmission of the authentication comparison data may be performed in response to the success of the first authentication process for the first user terminal 101.

The authentication comparison data may be partitioned in various manners. For example, the authentication comparison data may be partitioned based on authentication categories (or attributes). Here, the authentication categories may be classifications based on the types of information on user terminals. For example, the authentication categories may include RFID tags, WIFI SSIDs, beacons, sensor values, user email addresses, IDs, passwords, patterns, sensor identifiers, UUIDs, status information, MAC addresses, Bluetooth addresses, phone numbers, NFC tags, QR codes, barcodes, fingerprints, iris patterns, etc. In other words, each of the nodes 102-1 through 102-n of the temporary channel 40 may receive and store authentication comparison data of different authentication categories, which can be later used for comparison with authentication target data. Furthermore, the nodes 102-1 through 102-n of the temporary channel 40 may store the channel key along with the authentication comparison data.

Thereafter, the authentication system 100 may complete the authentication preparation procedure by sending an authentication preparation completion message, which includes the channel key, to the first user terminal 101 (S440).

Thereafter, the authentication system 100 may receive an authentication request, which includes the channel key of the temporary channel 40 and the authentication target data regarding the first user terminal 101, from the first user terminal 101 (S450).

Thereafter, in response to receiving the authentication request, the authentication system 100 may select the first user terminal 101 and randomly select some of the nodes 102-1 through 102-n, for example, one of the nodes 102-1 through 102-n, of the temporary channel 40. Then, the authentication system 100 may transmit a security key to the first user terminal 101 and the randomly-selected node and may enable the first authentication process for the first user terminal 101 to be performed with the security key (S460). Alternatively, in some embodiments, the random selection of a node to receive the security key and the transmission of the security key to the randomly-selected node may be performed before the authentication system 100 receives the authentication request.

The authentication system 100 may generate the security key by randomly extracting and combining authentication elements collected from the first user terminal 101 and the second user terminals 102. As already mentioned above, as the information regarding the first user terminal 101 and the second user terminals 102 can be stored in the blocks 20-1 through 20-n of the distributed ledger 20, the authentication elements can be obtained from the distributed ledger 20. In some embodiments, authentication elements regarding the first user terminal 101 may be directly obtained from the first user terminal 101 when an authentication preparation request or an authentication request is received from the first user terminal 101.

The authentication elements used for generating the security key may include at least one of region detection information, knowledge-based information, device information, and ownership information, as described earlier. In some embodiments, the authentication elements used for generating the security key may also include biometric information. Additionally, in some embodiments, the types of authentication elements used for generating the security key may be determined by the operator (or administrator) of the authentication system 100 or other services utilizing the authentication system 100. The operator may specify suitable types of authentication elements based on the nature of each provided service. In some cases, during a user registration process, users may be allowed to designate the types of authentication elements that are to be used for generating the security key.

The authentication system 100 may generate the security key by randomly extracting the authentication elements collected from the first user terminal 101 and the second user terminals 102 and combining the extracted authentication elements. In some cases, two or more security keys may be generated for the first authentication process for the first user terminal 101.

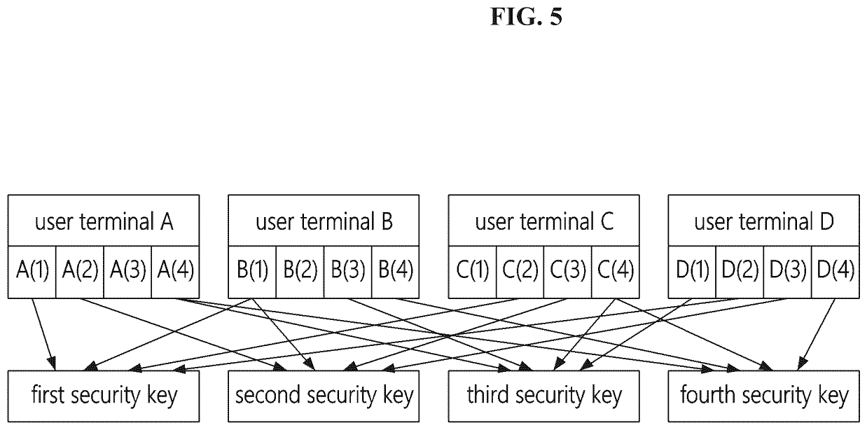

FIG. 5 is a schematic diagram illustrating how to generate a security key by randomly extracting and combining authentication elements collected from user terminals.

Referring to FIG. 5, the authentication system 100 may generate a security key by randomly extracting and combining some of the authentication elements stored for each user terminal in the distributed ledger 20, without any predetermined rules. In FIG. 5, various authentication elements collected for each of user terminals A, B, C, and D, which are the user terminals of four different users, are represented as A(N), B(N), C(N), or D(N).

Meanwhile, FIG. 5 illustrates four (or four types of) authentication elements are collected for each of user terminals A, B, C, and D, but the numbers of user terminals and authentication elements may vary depending on the circumstances. There may coexist user terminals for which a relatively larger number of authentication elements are collected and user terminals for which a relatively fewer number of authentication elements are collected.

Also, FIG. 5 illustrates an example of randomly extracting one authentication element from the authentication elements collected for each of user terminal to create a security key containing a total of four authentication elements. However, the number of authentication elements extracted per user terminal may differ. In this case, the number of authentication elements extracted per user terminal may be randomly determined.

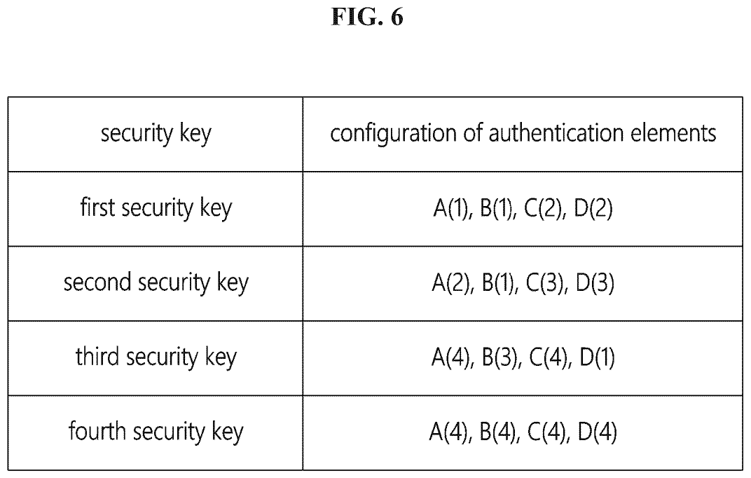

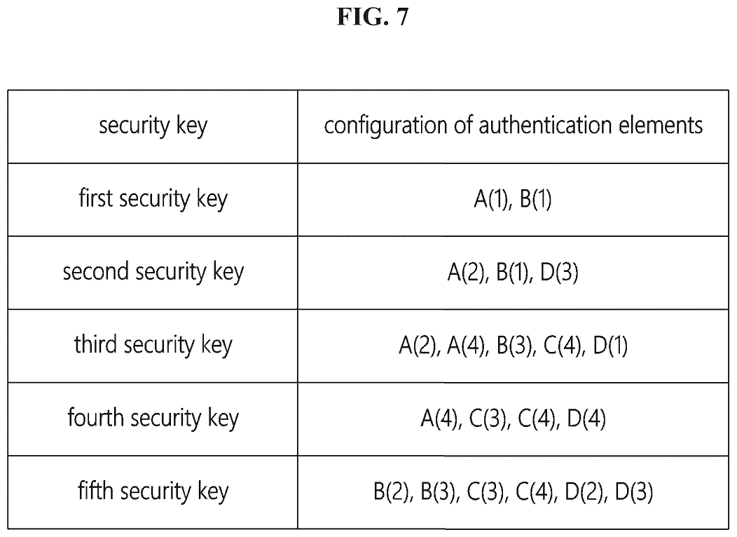

FIG. 6 presents a table showing the configurations of authentication elements for security keys that can be generated using the security key generation method depicted in FIG. 5. FIG. 7 presents a table showing the configurations of authentication elements for security keys that can be generated when the number of authentication elements extracted per user terminal varies from what is depicted in FIG. 5.

Referring back to FIG. 4, upon receiving the generated security key, the first user terminal 101 and some of the nodes 102-1 through 102-n of the temporary channel 40 may use a separate algorithm to convert the security key into a hash value. In S460, the authentication system 100 may receive a first hash value, which is obtained by the first user terminal 101's conversion of the security key, and a second hash value, which is obtained by some of the nodes 102-1 through 102-n's conversion of the security key. If the first and second hash values match, the authentication system 100 may determine the success of the first authentication process for the first user terminal 101 (S470).

Alternatively, in some embodiments, the authentication system 100 may also convert the security key into a hash value using a separate algorithm and may compare the hash value with the first and second hash values. Then, the authentication system 100 may determine the success of the first authentication process for the first user terminal 101 by comparing the hash value matches the first and second hash values.

The security key may be temporarily stored and set to be deleted after it is used in the first authentication process for the first user terminal 101 or has expired. When the security key is deleted in the first user terminal 101 and/or some of the nodes 102-1 through 102-n, a deleted status value may be transmitted to the authentication system 100 to notify the authentication system 100 of the deletion.

The security key used in the first authentication process for the first user terminal 101 is generated by cross-combining randomly extracted authentication elements, as mentioned above, and thus does not follow a particular rule or pattern. Consequently, even if the authentication elements or security key generation algorithms are compromised, it becomes almost impossible to generate the same security key.

Furthermore, since some nodes involved in the first authentication process for the first user terminal 101, i.e., the node(s) receiving the security key, is also randomly determined, attackers cannot ascertain their target. As a result, a significantly enhanced level of security can be ensured.

Thereafter, referring again to FIG. 4, the authentication system 100 may allow the second authentication process for the first user terminal 101 to proceed using the distributedly-transmitted authentication target data and the distributedly-transmitted authentication comparison data (S460).

Specifically, in S460, the authentication system 100 may identify the temporary channel 40 to authenticate the first user terminal 101 based on the channel key received from the first user terminal 101 and may distributedly transmit the authentication target data among the nodes 102-1 through 102-n of the temporary channel 40. The authentication system 100 may divide and transmit the authentication target data into categories, similar to the method used to transmit the authentication comparison data in S430. Particularly, the authentication system 100 may divide and transmit the authentication target data into the same categories as those sent to each node in S430.

Thereafter, the authentication system 100 may receive the result of comparison between the distributedly-transmitted authentication comparison data and the distributedly-transmitted authentication target data from the nodes 102-1 through 102-n of the temporary channel 40, and may determine the success of the second authentication process for the first user terminal 101 based on the received result of comparison between the authentication comparison data and the authentication target data (S470). For example, a node that has received authentication comparison data and authentication target data in a “MAC address” category may compare first MAC address data received as the authentication comparison data with second MAC address data received as the authentication target data to determine if the first and second MAC address data match, and may then transmit the result of the comparison to the authentication system 100.

Here, if the authentication system 100 receives the result that the distributedly-transmitted authentication comparison data and the distributedly-transmitted authentication target data match (or correspond) from more than a predetermined percentage of the total number of nodes in the temporary channel 40, the authentication system 100 may determine that the second authentication process for the first user terminal 101 is successful. The predetermined percentage can be set, for example, at 50%, but can be adjusted to a higher value to strengthen the level of authentication security.

Meanwhile, although not explicitly depicted in FIG. 4, once the authentication of the user terminal 101 is completed, the authentication system 100 may delete the temporary channel 40, the channel key, and the security key. All the information or data used to authenticate each user terminal may be discarded after each authentication process, and a new temporary channel may be created for each subsequent authentication process, ensuring a very high level of security.

According to the present disclosure, authentication is performed by multiple nodes 102-1 through 102-n, instead of being performed solely by the authentication system 100, resulting in reduced system complexity and authentication overhead. Moreover, as authentication is conducted through the nodes 102-1 through 102-n, the level of security can be significantly heightened, and the risk of hacking for the first user terminal 101 can be minimized due to the increased difficulty of tampering with data used to authenticate the first user terminal 101.

Additionally, the first and second authentication processes for the first user terminal 101 can be performed substantially concurrently, that is, in parallel. Alternatively, the second authentication process may be performed only when the first authentication process is determined to be successful, or vice versa.

The blockchain-based multi-node authentication method according to an embodiment of the present disclosure generates temporary security keys through random cross-combinations using distributed ledger technology, effectively preventing the potential leakage or hacking of passwords. Additionally, the blockchain-based multi-node authentication method according to an embodiment of the present disclosure can eliminate the inconvenience of using passwords, can avoid cumbersome steps such as selecting authentication certificates, and can thereby reduce the time required for authentication. Consequently, the security and convenience aspects of authentication processes can be enhanced significantly.

Furthermore, by adopting a decentralized server approach with the use of distributed ledger technology is employed, organizations implementing the blockchain-based multi-node authentication method according to an embodiment of the present disclosure can reduce the costs associated with password management.

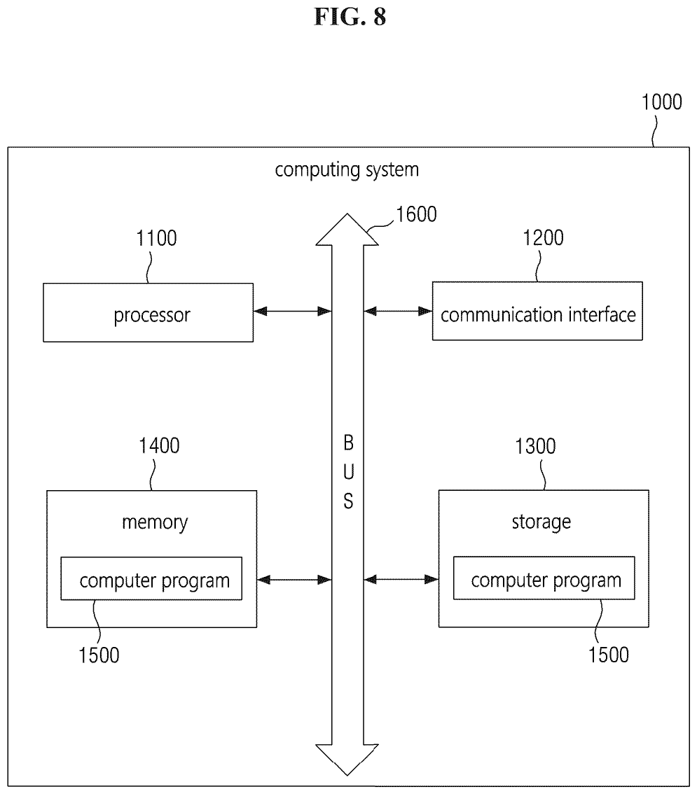

FIG. 8 is a hardware configuration view of a computing system according to some embodiments described in this disclosure.

Referring to FIG. 8, a computing system 1000 may include at least one processor 1100, a system bus 1600, a communication interface 1200, a memory 1400, which is for loading a computer program 1500 executed by the processor 1100, and a storage 1300, which is for storing the computer program 1500. FIG. 8 illustrates only the components relevant to the embodiments of the present disclosure. Therefore, those skilled in the art to which the present disclosure pertains will recognize that the computing system 1000 may also include other general components in addition to the components illustrated in FIG. 8. In other words, the computing system 1000 may include various components other than those illustrated in FIG. 8. Furthermore, in some cases, the computing system 1000 may be configured with some of the components illustrated in FIG. 8 omitted. Each of the components of the computing system 1000 will hereinafter be described.

The processor 1100 may control the general operation of each of the components of the computing system 1000. The processor may be configured to include at least one of a central processing unit (CPU), a micro-processor unit (MPU), a micro controller unit (MCU), a graphics processing unit (GPU), a neural processing unit (NPU), and any other form of processor known in the technical field of the present disclosure. Additionally, the processor 1100 may perform computations for at least one application or program to execute various operations/methods according to some embodiments of the present disclosure. The computing system 1000 may be equipped with one or more processors.

The memory 1400 may store various data, instructions, and/or information. The memory 1400 may load the computer program 1500 from the storage 1300 to execute the methods/operations according to some embodiments of the present disclosure. The memory 1400 may be implemented as a volatile memory, such as a random-access memory (RAM), but the present disclosure is not limited thereto.

The system bus 1600 may provide communication functionality between components of the computing system 1000. The system bus 1600 may be implemented in various forms, such as an address bus, a data bus, or control bus.

The communication interface 1200 may support both wired and wireless internet communication for the computing system 1000. Additionally, the communication interface 1200 may also support various communication methods other than Internet communication. To achieve this, the communication interface 1200 may be configured to include communication modules known in the technical field of the present disclosure.

Furthermore, the storage 1300 may non-temporarily store the computer program 1500. The storage 1300 may be configured with a non-volatile memory, such as a flash memory, a hard disk, a removable disk, or other forms of computer-readable recording media known in the technical field of the present disclosure.

The computer program 1500 may include one or more instructions that direct the processor 1100 to perform the methods/operations according to some embodiments of the present disclosure when the computer program 1500 is loaded into the memory 1400. That is, once the computer program 1500 is loaded into the memory 1400, the processor 1100 may perform the methods/operations according to some embodiments of the present disclosure by executing the one or more instructions.

In some embodiments, the computer program 1500 may include: instructions for receiving an authentication preparation request from a first user; instructions for generating a channel key for identifying a temporary channel, in which the authentication of a first user terminal is to be performed, wherein the temporary channel includes multiple nodes corresponding to multiple second user terminals, which are to be involved in the authentication of the first user terminal and have been randomly selected from user terminals other than the first user terminal; instructions for collectively transmitting the channel key to the nodes and distributedly transmitting authentication comparison data, which is used for the authentication of the first user terminal, among the nodes; instructions for transmitting an authentication preparation completion message, which contains the channel key, to the first user terminal; instructions for receiving an authentication request, which includes the channel key and authentication target data regarding the first user terminal, from the first user terminal; instructions for proceeding with the authentication of the first user terminal in response to receiving the authentication request, wherein the authentication of the first user terminal includes first authentication and second authentication processes, the first authentication process is an authentication process using a security key transmitted to the first user terminal and some of the nodes that is randomly selected, the security key is generated by randomly extracting and combining authentication elements collected from the first user terminal and the second user terminals, and the second authentication process is an authentication process using the distributedly-transmitted authentication target data and the distributedly-transmitted authentication comparison data; instructions for receiving the result of the comparison between the distributedly-transmitted authentication comparison data and the distributedly-transmitted authentication target data from the nodes; and instructions for determining the success of the authentication of the first user terminal based on the received result of the comparison between the authentication comparison data and the authentication target data. The authentication comparison data and the authentication elements collected from the second user terminals may be obtained from a distributed ledger.

The instructions for proceeding with the authentication of the first user terminal may include: instructions for transmitting the security key to the first user terminal and the randomly-selected node in response to receiving the authentication request; instructions for receiving a first hash value, which is obtained by the first user terminal's conversion of the security key, and a second hash value, which is obtained by the randomly-selected node's conversion of the security key; and instructions for determining the first authentication process to be successful if the first and second hash values match.

Both the authentication comparison data and the authentication target data may be classified into multiple categories, the instructions for distributedly transmitting the authentication comparison data among the nodes may include partitioning the authentication comparison data based on the categories and transmitting the partitioned authentication comparison data to different nodes, and the instructions for proceeding with the authentication of the first user terminal may include partitioning the authentication target data based on the categories and transmitting the partitioned authentication target data to the different nodes according to the same categories as the partitioned authentication comparison data.

The instructions for receiving the authentication preparation request from the first user may include instructions for randomly selecting a particular authentication server, in which the first and second authentication processes are to be performed, from among a plurality of authentication servers.

In some embodiments, the computing system 1000 of FIG. 8 may refer to a virtual machine implemented based on cloud technology. For example, the computing system 1000 may be a virtual machine operating on one or more physical servers within a server farm. In this example, some or all of the components depicted in FIG. 8, such as the processor 1100, the memory 1400, and the storage 1300, may be virtual hardware. Additionally, the communication interface 1200 may be implemented as a virtualized networking element, such as a virtual switch.

The computing system 1000 that can implement the authentication system 100 has been described so far with reference to FIG. 8.

Various embodiments of the present disclosure and their effects have been mentioned so far with reference to FIGS. 1 through 8. The effects based on the technical ideas of the present disclosure are not limited to those mentioned above, and other effects not mentioned can be clearly understood by those skilled in the art from the disclosure herein.

Furthermore, it should be understood that just because multiple components have been described as being combined or operating together in the above examples, the technical ideas of the present disclosure are not necessarily limited to such examples. In other words, within the scope of the technical ideas of the present disclosure, all the components may be selectively combined into one or more configurations and operate accordingly.

The technical ideas of the present disclosure can be implemented as computer-readable code on a computer-readable medium. Computer programs recorded on computer-readable storage media can be transmitted to other computing systems via networks such as the Internet and can be installed on those other computing systems, allowing them to be used in those systems.

Although the operations in the drawings are depicted in a particular order, it should not be understood that the operations must be executed in that particular order or sequentially, or that all the depicted operations must be executed to achieve the desired results. In certain situations, multitasking and parallel processing may be advantageous.

While various embodiments of the present disclosure have been described with reference to the accompanying drawings, those skilled in the art in the relevant technical field will understand that the technical ideas of the present disclosure may be implemented in other specific forms without altering the essence or essential features of the present disclosure. Therefore, the embodiments described above should be considered illustrative and not restrictive in any way. The scope of protection of the present disclosure should be interpreted based on the claims below, and any technology that is equivalent to the technical ideas defined by the present disclosure should be construed as falling within the scope of the rights defined by the technical ideas of the present disclosure.

What is claimed is:

1. A blockchain-based multi-node authentication method performed by a computing system, comprising:
receiving an authentication preparation request from a first user;
generating a temporary channel, in which the authentication of a first user terminal of the first user is to be performed, and a channel key for identifying the temporary channel in response to the authentication preparation request, the temporary channel including multiple nodes respectively corresponding to multiple second user terminals, which are to be involved in the authentication of the first user terminal and are randomly selected from user terminals other than the first user terminal;
collectively transmitting the channel key to the nodes and distributedly transmitting authentication comparison data, which is to be used in the authentication of the first user terminal, among the nodes;
transmitting an authentication preparation completion message, which includes the channel key, to the first user terminal;
receiving an authentication request, which includes the channel key and authentication target data regarding the first user terminal, from the first user terminal:
proceeding with the authentication of the first user terminal in response to receiving the authentication request, the authentication of the first user terminal including first and second authentication processes, the first authentication process being an authentication process using a security key transmitted to the first user terminal and some of the nodes that is randomly selected, the security key being generated by randomly extracting and combining authentication elements collected from the first user terminal and the second user terminals, and a second authentication process being an authentication process using the distributedly-transmitted authentication target data and the distributedly-transmitted authentication comparison data;
receiving a result of comparison between the distributedly-transmitted authentication comparison data and the distributedly-transmitted authentication target data from the nodes; and
determining the success of the authentication of the first user terminal based on the received result of comparison between the distributedly-transmitted authentication comparison data and the distributedly-transmitted authentication target data,
wherein the authentication comparison data and the authentication elements collected from the second user terminals are obtained from a distributed ledger.

2. The blockchain-based multi-node authentication method of claim 1, wherein the proceeding with the authentication of the first user terminal, comprises transmitting a security key to the first user terminal and the randomly-selected node in response to receiving the authentication request, receiving a first hash value, which is obtained by the first user terminal's conversion of the security key, and a second hash value, which is obtained by the randomly-selected node's conversion of the security key, and determining the first authentication process to be successful if the first and second hash values match.

3. The blockchain-based multi-node authentication method of claim 1, wherein the security key is a one-time or temporary security key.

4. The blockchain-based multi-node authentication method of claim 1, wherein
both the authentication comparison data and the authentication target data are classified into multiple categories,
the distributedly transmitting the authentication comparison data among the nodes, comprises partitioning the authentication comparison data based on the categories and transmitting the partitioned authentication comparison data to different nodes, and
the proceeding with the authentication of the first user terminal, comprises partitioning the authentication target data based on the categories and transmitting the partitioned authentication target data to the different nodes according to the same categories as the partitioned authentication comparison data.

5. The blockchain-based multi-node authentication method of claim 4, wherein the determining the success of the authentication of the first user terminal, comprises determining the second authentication process to be successful if a result is received from more than a predetermined number of nodes showing that the distributedly-transmitted authentication comparison data and the distributedly-transmitted authentication target data match.

6. The blockchain-based multi-node authentication method of claim 1, further comprising:
if the determining the first authentication process to be successful is completed, deleting the temporary channel, the channel key, and the security key.

7. The blockchain-based multi-node authentication method of claim 1, wherein the receiving the authentication preparation request from the first user, comprises randomly selecting a particular authentication server, in which the first and second authentication processes are to be performed, from among a plurality of authentication servers.

8. A blockchain-based multi-node authentication system comprising:
a communication interface;
a memory in which a computer program is loaded; and
a processor executing the computer program,
wherein
the computer program includes: instructions for receiving an authentication preparation request from a first user; instructions for generating a temporary channel, in which the authentication of a first user terminal of the first user is to be performed, and a channel key for identifying the temporary channel in response to the authentication preparation request, the temporary channel including multiple nodes respectively corresponding to multiple second user terminals, which are to be involved in the authentication of the first user terminal and are randomly selected from user terminals other than the first user terminal; instructions for collectively transmitting the channel key to the nodes and distributedly transmitting authentication comparison data, which is to be used in the authentication of the first user terminal, among the nodes; instructions for transmitting an authentication preparation completion message, which includes the channel key, to the first user terminal, instructions for receiving an authentication request, which includes the channel key and authentication target data regarding the first user terminal, from the first user terminal; instructions for proceeding with the authentication of the first user terminal in response to receiving the authentication request, the authentication of the first user terminal including first and second authentication processes, the first authentication process being an authentication process using a security key transmitted to the first user terminal and some of the nodes that is randomly selected, the security key being generated by randomly extracting and combining authentication elements collected from the first user terminal and the second user terminals, and a second authentication process being an authentication process using the distributedly-transmitted authentication target data and the distributedly-transmitted authentication comparison data; instructions for receiving a result of comparison between the distributedly-transmitted authentication comparison data and the distributedly-transmitted authentication target data from the nodes; and instructions for determining the success of the authentication of the first user terminal based on the received result of comparison between the authentication comparison data and the authentication target data, and
the authentication comparison data and the authentication elements collected from the second user terminals are obtained from a distributed ledger.

9. The blockchain-based multi-node authentication system of claim 8, wherein the instructions for proceeding with the authentication of the first user terminal include instructions for transmitting a security key to the first user terminal and the randomly-selected node in response to receiving the authentication request, instructions for receiving a first hash value, which is obtained by the first user terminal's conversion of the security key, and a second hash value, which is obtained by the randomly-selected node's conversion of the security key, and instructions for determining the first authentication process to be successful if the first and second hash values match.

10. The blockchain-based multi-node authentication system of claim 8, wherein
both the authentication comparison data and the authentication target data are classified into multiple categories,
the instructions for distributedly transmitting the authentication comparison data among the nodes include instructions for partitioning the authentication comparison data based on the categories and transmitting the partitioned authentication comparison data to different nodes, and
the instructions for proceeding with the authentication of the first user terminal include instructions for partitioning the authentication target data based on the categories and transmitting the partitioned authentication target data to the different nodes according to the same categories as the partitioned authentication comparison data.

11. The blockchain-based multi-node authentication system of claim 8, wherein the instructions for receiving the authentication preparation request from the first user include instructions for randomly selecting a particular authentication server, in which the first and second authentication processes are to be performed, from among a plurality of authentication servers.
